(19) United States
(12) Patent Application Publication
(10) Pub. No.: US 2024/0212079 A1
(43) Pub. Date: Jun. 27, 2024

(54) SYSTEM AND METHOD FOR PROVIDING LEGAL ADVICE DURING A LAW ENFORCEMENT ENCOUNTER

(71) Applicant: Anthony Jerome Bolden, Daytona Beach, FL (US)

(72) Inventor: Anthony Jerome Bolden, Daytona Beach, FL (US)

(21) Appl. No.: 18/527,844

(22) Filed: Dec. 4, 2023

Related U.S. Application Data
(60) Provisional application No. 63/434,662, filed on Dec. 22, 2022.

(51) Int. Cl. G06Q 50/18; G06Q 20/08; G06Q 30/018; G06Q 50/26; H04M 3/22

(52) U.S. Cl. CPC G06Q 50/18; G06Q 20/085; G06Q 30/018; G06Q 50/265; H04M 3/2281

(57) ABSTRACT

A method, a system and a computer program product provides law enforcement encounter monitoring and legal counsel to a user involved in a law enforcement encounter including but not limited to a traffic stop. A traffic stop counsel (TSC) utility module enables the user to access law enforcement encounter related features via a mobile application. Subject to a verification procedure, the TSC utility provides an interactive prompt that enables the user to call an attorney that is licensed in the current jurisdiction in order to receive legal counsel and advice during interactions with a law enforcement officer during the law enforcement encounter including enabling the user to permit the attorney to witness the interaction via the user's mobile device and provide legal advice and guidance to the user.

### CROSS-REFERENCE TO RELATED APPLICATION

This application claims the benefit of U.S. Provisional Patent Application 63/434,662 filed Dec. 22, 2022, which is hereby incorporated by reference herein in its entirety.

### FIELD OF THE INVENTION

The present invention relates generally to providing remote legal advice, and more particularly, to providing remote legal counsel for law enforcement encounters.

### BACKGROUND OF THE INVENTION

Traffic stops are one of the most common acts of policing. In fact, most people do not interact with the police except when being stopped for a traffic violation. Officers engaged in traffic enforcement may decide to stop a driver based on a number of potential violations, including expired tags, blown headlights, speeding, and not using a turn signal. During a traffic stop, the officer may conduct a search of vehicle, issue a citation, arrest the driver, or let the driver go with or without a warning.

A traffic stop is a temporary detention of a driver of a vehicle by police to investigate a possible crime or minor violation of law. Whether an individual is pulled over because of allegedly speeding or because the officer thinks he is intoxicated, there are procedures and laws police officers must follow. Traffic stops can, at times, lead to interactions between a police officer and a driver that escalate into dangerous and even fatal encounters for drivers and passengers. When law enforcement oversteps their bounds, civil rights violations and instances of excessive force and police brutality can occur.

Ideally, it would be extremely useful to provide a system that provides increased protection of the rights of the driver and occupants of vehicles when in contact with law enforcement officers during traffic stops. In addition, the system should help to reduce the likelihood of individuals making the wrong choices or decisions during a traffic stop. Additionally, the system should enable the traffic stop encounters to proceed efficiently and effectively with minimal concern or worries of escalating violence. There is also a need to reduce injuries or death to clients and/or law enforcement personnel.

Accordingly, there is need for a solution that increases safety and reduces violence, which solution helps to provide safer traffic stop encounters and provides guidance to enhance a decision-making by the user that can be expected to protect a driver's civil rights and prevent harm or even death to a driver or passenger.

### SUMMARY OF THE INVENTION

The present invention is directed to a method, a system, and a computer program product for providing traffic stop monitoring and legal counsel to a user involved in a law enforcement encounter including but not limited to a traffic stop. A traffic stop counsel (TSC) utility/module enables the user to access traffic stop related features via a mobile application. According to an aspect, the TSC utility enables the user to perform user identification (ID) verification and to verify his location. Following ID and location verification, the TSC utility provides an interactive prompt that enables the user to call an attorney that is licensed in the current jurisdiction in order to receive legal counsel and advice during interactions with a law enforcement officer during the law enforcement encounter. In response to a call between the user and the attorney being connected, the TSC utility enables the user to permit the attorney to witness the interaction via the user's mobile device. Additionally, the attorney is able to provide legal advice and guidance to the user during the law enforcement encounter. According to an aspect, the TSC utility enables the user to save a record of the law enforcement encounter as a form of legal documentation. The TSC utility initiates a rating feature to enable the user to rate the mobile application and/or the attorney service.

According to one or more aspects, the TSC utility determines an overall rating for an attorney based on ratings provided by various users/drivers using the rating feature. According to an implementation, the TSC utility presents the overall attorney rating to a user to facilitate an attorney selection by the user.

According to one or more aspects, the user devices include a personal/laptop/tablet computer and a smart-phone. According to an aspect, the data processing (user) device is one or more of an Android platform and an IOS platform device.

According to one or more aspects, the TSC module is used to activate a live legal consultation/witnessing for motorists that are involved in vulnerable situations based on encounters associated with routine traffic stops.

According to one or more aspects, the monitoring and attorney servicing functions provided by the traffic stop monitoring and legal counsel services application can be initiated via one or more of voice activation, touch activation, and hands-free activation.

According to an aspect, in response to a user's request, the TSC module can provide a livestream which can be recorded in the cloud to enable a safe and secure storage of the traffic stop record.

The methods and systems described herein can be implemented by data processing systems, such as one or more smartphones, tablet computers, desktop computers, laptop computers, smart watches, wearable, audio accessories, on-board computer, and other data processing systems and other consumer electronic devices. The methods and systems described herein can also be implemented by one or more data processing systems which execute executable computer program instructions, stored in one or more non-transitory machine-readable media that cause the one or more data processing systems to perform the one or more methods described herein when the program instructions are executed. Thus, the embodiments described herein can include methods, data processing systems, and non-transitory machine-readable media.

The above summary does not include an exhaustive list of all embodiments in this disclosure. All systems and methods can be practiced from all suitable combinations of the various aspects and embodiments summarized above, and also those disclosed in the detailed description below.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 illustrates a block diagram representation of an example data processing system within which certain features of the present disclosure can be implemented, according to one or more embodiments;

FIG. 2 illustrates a computer and communications network environment for enabling remote monitoring of a traffic stop and enabling communication between a driver and an attorney during traffic stop interactions between a police officer and the driver, according to one or more embodiments of the disclosure;

FIG. 3 presents a screenshot of a graphical user interface (GUI) by which a user can make calls to an attorney in order to receive legal advice during a traffic stop, according to one or more embodiments;

FIG. 4 presents a flow chart illustrating the process of facilitating communication between a driver and an attorney during a traffic stop, according to one or more embodiments; and

FIG. 5 presents a flow chart illustrating the process of selecting and assigning an attorney for communication with a user in order to provide legal counsel, and providing payment for attorney services, according to one or more embodiments.

Like reference numerals refer to like parts throughout the several views of the drawings.

### DETAILED DESCRIPTION

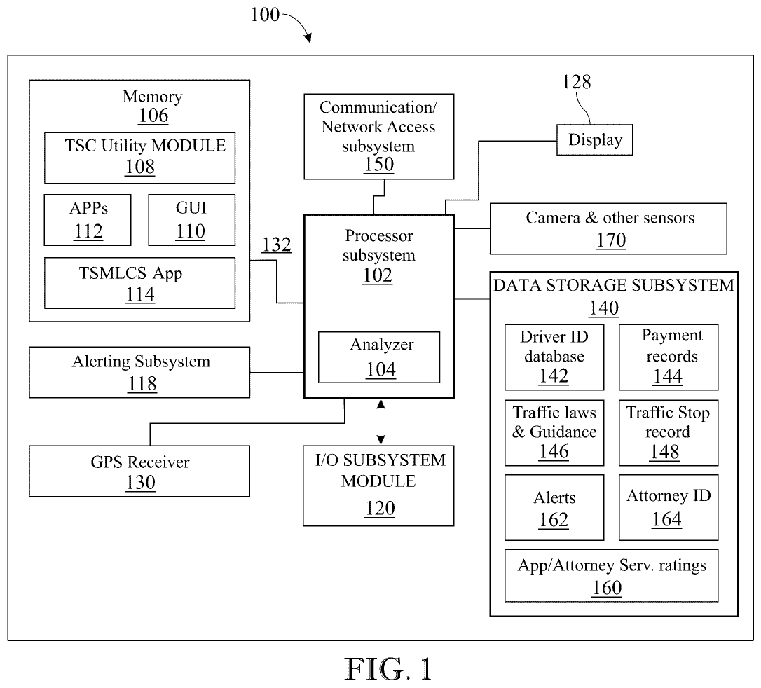

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present disclosure is directed toward providing an online platform for monitoring law enforcement encounters and providing legal advice to a user during a law enforcement encounter between a law enforcement officer and the user. For ease of understanding the principles of the disclosed embodiments, a traffic stop will be used as the exemplary law enforcement encounter, but it will be understood that this is not meant to be limiting in any way and any law enforcement encounter having a legal consequence (e.g., a criminal charge) to the user is consistent with the principles of the disclosed embodiments. That is, the principles of the disclosed embodiments apply equally to any law enforcement encounter that involves either a custodial interrogation or a non-custodial interrogation and where such law enforcement encounter may occur involving various actions or situations (e.g., traffic stops, on foot, general harassment, boat, bike, home welfare checks, etc.) As will be appreciated, in the United States in a custodial interrogation, the person is under arrest or otherwise not free to leave, whereas in a non-custodial interrogation, they can leave at any time. Another important difference is that Miranda warnings are required before a custodial interrogation but not before a non-custodial one.

With reference now to the figures, and beginning with FIG. 1, there is depicted a block diagram representation of an example data processing system (DPS), as utilized within one embodiment. DPS may be a server, a digital audio workstation, a personal computer, a portable device, such as a personal digital assistant (PDA), a smartphone, and/or other types of electronic devices that may generally be considered processing devices or computing systems/devices. As illustrated, DPS 100 comprises at least one processor subsystem 102 connected to system memory 106 via system bus/interlink 132. DPS 100 executes one or more computer programs/applications to begin monitoring law enforcement encounters (e.g., traffic stops) and providing legal counsel to a user involved in a law enforcement encounter, according to the present disclosure.

In one or more embodiments, data processing device 100, which is managed by processor subsystem 102, also includes communication/network access subsystem 150, data storage subsystem 140, alerting subsystem 118, GPS receiver 130, cameras, and other sensors 170, and input/output (I/O) subsystem 120. As shown, processor subsystem 102 includes an analyzer module 104 to support the data analysis functionality of DPS 100. Processor subsystem 102 executes program code to provide operating functionality of data processing device 100. The software and/or firmware modules have varying functionality when their corresponding program code is executed by processor subsystem 102 or secondary processing devices (not explicitly shown) within DPS 100.

As illustrated, the DPS 100 includes an I/O subsystem 120. The I/O subsystem 120 includes user interface devices including output devices such as audio output device(s)/speaker, and a display device (not shown). In one or more implementations, the display device includes touch screen functionality enabling a display device to function as both an input device and an output device. In addition, I/O subsystem 120 includes input devices including a microphone, a keypad, and a mouse.

Processor subsystem 102 is communicatively coupled, via system bus/interlink 132, to device memory 106. In one or more embodiments, processor subsystem 102 is communicatively coupled via system bus/interlink 132 to communication/network access subsystem 150, data storage subsystem 140, and input/output subsystem 120. The bus/interlink 132 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components.

Communication/network access subsystem 150 may be configured to enable DPS 100 to communicate with a plurality of personal computing devices. The communication subsystem may include wired and/or wireless communication devices to facilitate networked communication. Communication/network access subsystem 150 also includes a Network Access Module by which DPS 100 may connect to one or more access/external networks such as the Internet or wide area network (WAN), or an internal network such as an Ethernet (local area network-LAN) or a Virtual Private Network (VPN).

In addition to the above described hardware components of DPS 100, various features of the invention are completed/supported via software (or firmware) code or logic stored within memory 106 or other storage and executed by processor subsystem 102. Thus, for example, illustrated within memory 106 are a number of software/firmware/logic components, including a traffic stop monitoring and legal counsel services (TSMLCS) application/module 114 and other applications (apps) 112. According to an aspect, the TSMLCS application 114 is an online/Internet-based mobile application. In addition, memory 106 comprises a traffic stop counsel (TSC) utility module 108. Device memory 106 further includes an operating system (OS) (not shown), a firmware interface, such as basic input/output system (BIOS) or Uniform Extensible Firmware Interface (UEFI), and firmware (not shown). Device memory 106 includes a graphical user interface (GUI) 110 and other computer data (not explicitly shown) used by the TSC utility module 108 and/or the traffic stop monitoring and legal counsel services application 114.

Data storage subsystem 140 enables further storage and retrieval of data, instructions, and code. In particular, data storage subsystem 140 provides applications, program code, and stored data on nonvolatile storage that is accessible by processor subsystem 102. For example, data storage subsystem 140 can provide, for use by the TSC utility module 108, the driver/user identification (ID) database 142, payment records 144, traffic laws and guidance database (DB) 146, traffic stop records 148, alerts 162, attorney identification (ID) 164, and traffic stop application and attorney services ratings 160. In addition, data storage subsystem 140 can provide a selection of program code and applications such as the traffic stop monitoring and traffic stop monitoring and legal counsel services application 114, and other related application(s) that can be used to monitor traffic stops and provide attorney services for traffic stop interactions between a police officer and a driver. These applications can be loaded into device memory 106 for execution by processor subsystem 102.

In actual implementation, the TSC utility module 108 may be combined with the traffic stop monitoring and legal counsel services application 114 to provide a single executable component, collectively providing the various functions of each individual component when the corresponding combined component is activated. For simplicity, the TSC utility module 108 is illustrated and described as a stand-alone or separate logic/firmware component, which provides specific functions, as described below.

In one embodiment, DPS 100 communicates with a software deploying server (not shown) via a network (e.g., the Internet) using communication subsystem/network access module 150. Then, TSC utility module 108 may be deployed from/on the network, via the software deploying server. With this configuration, the software deploying server performs all of the functions associated with the execution of TSC utility module 108. Accordingly, DPS 100 is not required to utilize internal computing resources of DPS 100 to execute TSC utility module 108.

The TSC utility module 108 provides an online platform for monitoring traffic stops and providing attorney legal services during traffic stop interactions between a police officer and a driver. The driver/user can be presented with audio, visual and/or textual content associated during the various stages of monitoring and reporting on traffic stop interactions by the online platform via an output device of the I/O subsystem. According to an aspect of the present disclosure, the TSC utility module 108 enables the individual to provide responses/feedback to the presented content via the GUI 110. According to one or more aspects, the individual/user can be presented with aural content via the speakers. The participant may also be visually presented via the display device with image, video and/or textual content. In addition, the participant may be visually presented with one or more associated selection buttons within the GUI 110. Using an input device, such as the mouse, the keypad or the microphone, the participant can provide an input selection as a response to presented content.

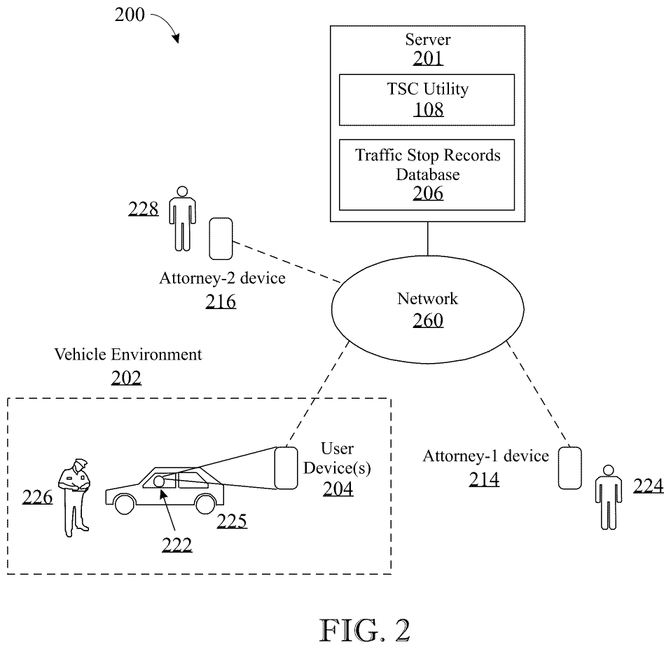

Certain of the functions supported and/or provided by the TSC utility module 108 are implemented as processing logic (or code) executed by processor subsystem 102 and/or other device hardware, which processing logic enables the device to implement/perform those function(s). Among the software code/instructions/logic provided by the TSC utility module 108, and which are specific to the disclosure, are: (a) logic for receiving from a user/driver an activation trigger to initiate execution of the traffic stop monitoring and legal counsel services (mobile) application: (b) logic for detecting selection of Traffic Stop features as a result of the user's interacting with a traffic stop Icon; (c) logic for providing an interactive “Call Attorney” button prompt that when selected verifies that the user wishes to initiate a call with an attorney to obtain legal advice; (d) logic for detect that a call is being initiated by the user based on a detected interaction with the Call Attorney button prompt; (e) logic for detecting that an active call connection between user and attorney has been established; (f) logic for enabling the attorney to witness the traffic stop event via a camera and a microphone of the user's device, and guide the user through an understanding of his legal rights; (g) logic for creating an audio-visual record of the traffic stop as a form of legal documentation; (h) logic for initiating an App rating feature to enable the user to rate the mobile application and/or the attorney service; (i) logic for verifying a user's ID and location; (j) logic for initiating a search for available candidate attorneys in the current jurisdiction; and (k) logic for completing, via the mobile APP, a payment transaction for traffic attorney services using a linked user account. According to the illustrative embodiment, when Processor subsystem 102 executes the TSC utility module 108, DPS 100 initiates a series of functional processes that enable the above functional features as well as additional features/functionality. These features/functionalities are described in greater detail below within the description of FIGS. 2-5.

Those of ordinary skill in the art will appreciate that the hardware components and basic configuration depicted in FIG. 1 may vary. The illustrative components within DPS 100 are not intended to be exhaustive, but rather are representative to highlight essential components that are utilized to implement the present disclosure. For example, other devices/components may be used in addition to or in place of the hardware depicted. The depicted example is not meant to imply architectural or other limitations with respect to the presently described embodiments and/or the general disclosure.

Referring now to FIG. 2, a computer/communications network 200 for remote monitoring of a traffic stop and enabling communication between a driver and an attorney during traffic stop interactions between a police officer and the driver, according to one or more embodiments of the disclosure. As illustrated in the computer/communications network 200, a number of computing/electronic devices are included. These computing devices, which can be similarly configured to DPS 100 (FIG. 1), include a server 201, a user/driver device(s) 204, a first attorney device 214, and a second attorney device(s) 216. The various computing devices are connected by a network 260. The network 260 can be any of the various networks, including a LAN or a WAN/Internet, described in FIG. 1. Also illustrated in the computer/communications network 200 are a vehicle 225 having a driver 222, and a police officer 226 located proximate to the vehicle 225 and the driver 222. As illustrated, the vehicle 225 and the driver 222, and the police officer 226 are all located with a vehicle environment 202. Additionally, the first attorney 224 and second attorney 228 are shown within the computer/communications network 200.

The computer/communications network 200 allows laws and guidance information 146 to be sent by the server to the various individuals at the respective devices. In addition, responses from the various individuals can be received by the server 201. The server 201 includes a traffic stop records database 206 to store data obtained based on activities surrounding various traffic stop events. Based on the communicated/received information, the TSC utility/module 108 can download configuration and control information to the various individual/user devices, respectively.

According to one or more aspects, and as illustrated in FIG. 2, a vehicle driver 222 with his device 204 are shown within a vehicle environment 202. According to an aspect, the driver 222 can be used to represent users including drivers and passengers within a vehicle 225 that is pulled over by a police officer 226 during a traffic stop event. According to one or more related aspects, the driver 222, using device 204, is able to transmit data captured by the user's device 204 and/or request that monitored/recorded traffic stop data be transmitted to a server and/or a remote attorney (e.g., the first attorney 224).

According to one or more aspects, the user devices 204, 214, and 216 include a personal/laptop/tablet computer and a smart-phone. According to an aspect, the data processing (user) device is one or more of an Android platform and an IOS platform device.

According to one or more aspects, the TSC utility module 108 and TSMLCS application 114 are used to activate a live legal consultation/witnessing for motorists that are involved in vulnerable situations based on encounters associated with routine traffic stops.

According to one or more aspects, the monitoring and attorney servicing functions provided by the traffic stop monitoring and legal counsel services application 114 can be initiated via one or more of voice activation, touch activation, and hands-free activation.

According to an aspect, in response to a user's request, the TSC utility module 108 can provide a livestream which can be recorded in the cloud to enable a safe and secure storage of the traffic stop record.

According to an aspect, the TSC utility module 108 provides a date and a timestamp for each message and/or event associated with recording and reporting on a traffic stop encounter.

According to an aspect, the TSC utility module 108 shares a driver's location and/or location tracking information with individuals/attorneys selected by the app/driver, based on the driver's request.

According to an aspect, the TSC utility module 108 enables an individual using the TSLMC app 114 (e.g., a mobile application) to connect to a lawyer in real time for legal advice protection from corruption, and documentation of the events that takes place during a traffic stop. The lawyer will advise their client on what they should do and which orders to follow from the police officer based on their rights.

According to an aspect, the TSC utility module 108 can connect an individual to an attorney that practices in any of the various practice areas of law in order to efficiently provide a user advice on different subjects or aspects of the law.

According to an implementation, the TCS utility module 108 provides a user with access to the legal counsel/advice/consultation services with an attorney based on the user having a paid subscription. According to an implementation, the TCS utility module 108 provides a user with access to the legal counsel/advice/consultation services with an attorney without any type of prior subscription and may be on a “one time” basis.

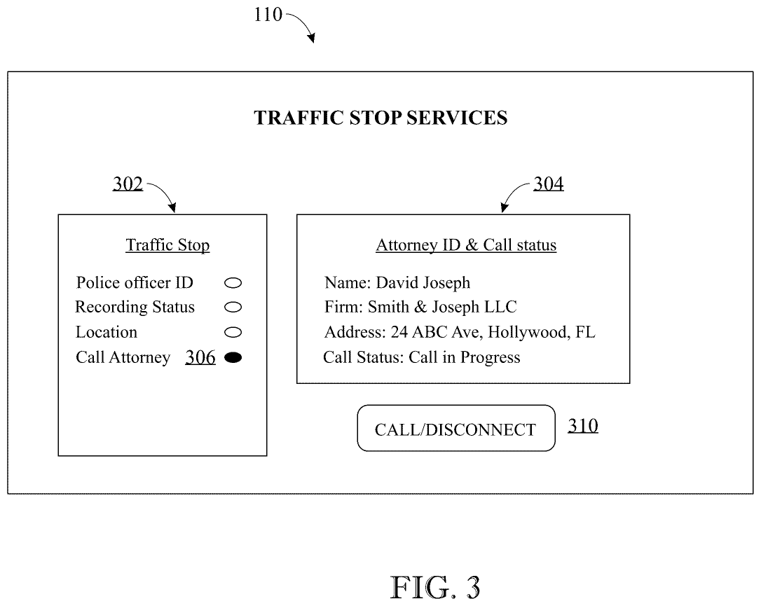

FIG. 3 presents a screenshot of a graphical user interface (GUI) by which a user can make calls to an attorney in order to receive legal advice during a traffic stop, according to one or more embodiments. As illustrated, GUI 110 includes a number of windows including a traffic stop menu window 302 and an Attorney ID data and call status window 304. GUI 110 is an example interface that is provided by the TSMLCS application 114. When a user activates the TSMLCS application 114, the TSC utility module 108 presents GUI 110 on display 128 of DPS 100. Attorney ID & call status window 304 shows information relevant and responsive to a user's selection in traffic stop meno window 302.

Traffic stop menu window 302 presents a number of steps/aspects associated with facilitating traffic stop rights protection and safety including: (i) Police officer ID Data; (ii) Recording Status; (iii) Location; and (iv) Attorney call. When the user selects the “Police officer ID Data” option, the TSC utility module 108 presents in Police officer ID Data window (not shown) a data entry interface in which the user is able to provide identification (ID) information for the police officer making the traffic stop. When the user selects the “Call Attorney” option, the TSC utility module 108 presents the Attorney ID and Call Status window identification (ID) information for an attorney that has been selected to provide legal counsel to the driver during the traffic stop. As illustrated in the Attorney ID and Call Status window 304, the attorney's name is David Joseph, the firm for which the attorney works as a partner is Smith & Joseph LLC, and the address of the attorney's firms is 24 ABC avenue in Hollywood, Florida. The TSC utility module 108 illustrates an active/current user selection by blacking out an interactive selection oval positioned adjacent to and to the right of the selected option. For example, the blacked out interactive selection oval 306 indicates that the “Attorney ID and Call Status window” option is selected. Also illustrated in the screenshot of GUI 110 is the CALL/DISCONNECT button 310. When the user has reviewed the ID data corresponding to the attorney selected by the traffic stop application, the user is able to begin the call with the selected attorney by pressing/interacting with the CALL/DISCONNECT button 310. Furthermore, when the traffic stop, the consultation and/or the conversation is over, the user is able to end the call with the selected attorney by pressing/interacting with the CALL/DISCONNECT button 310.

The selectable/presented options/items provided by GUI 110 have been described based on the specific example options/items illustrated in the FIG. 3 However, this particular presentation of menu, function and options/items is provided for illustrative purposes, and the disclosure is by no means limited to the specific options/items and/or number of options/items presented

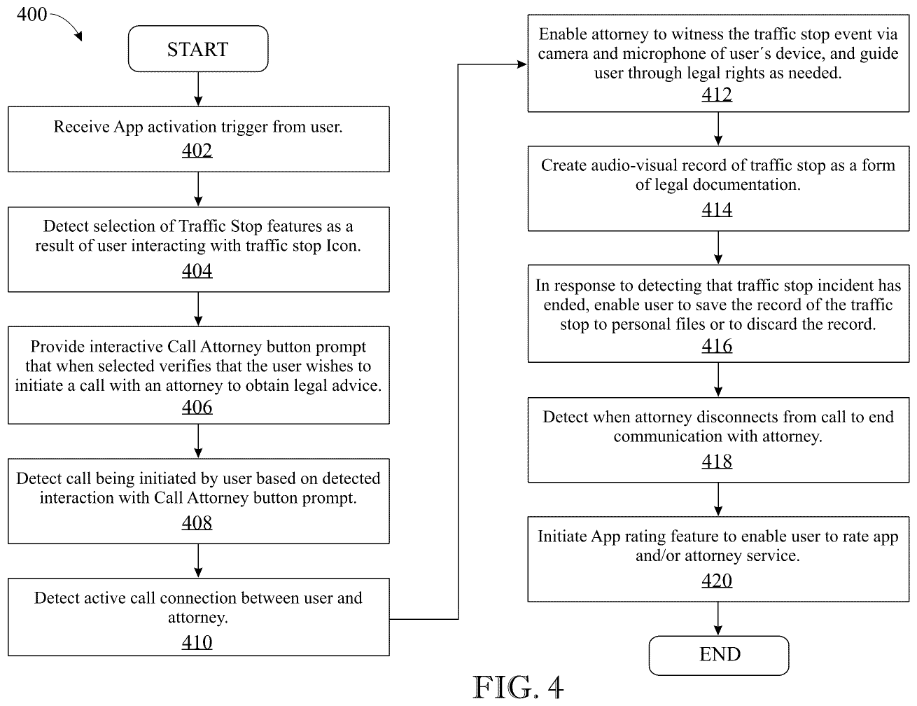

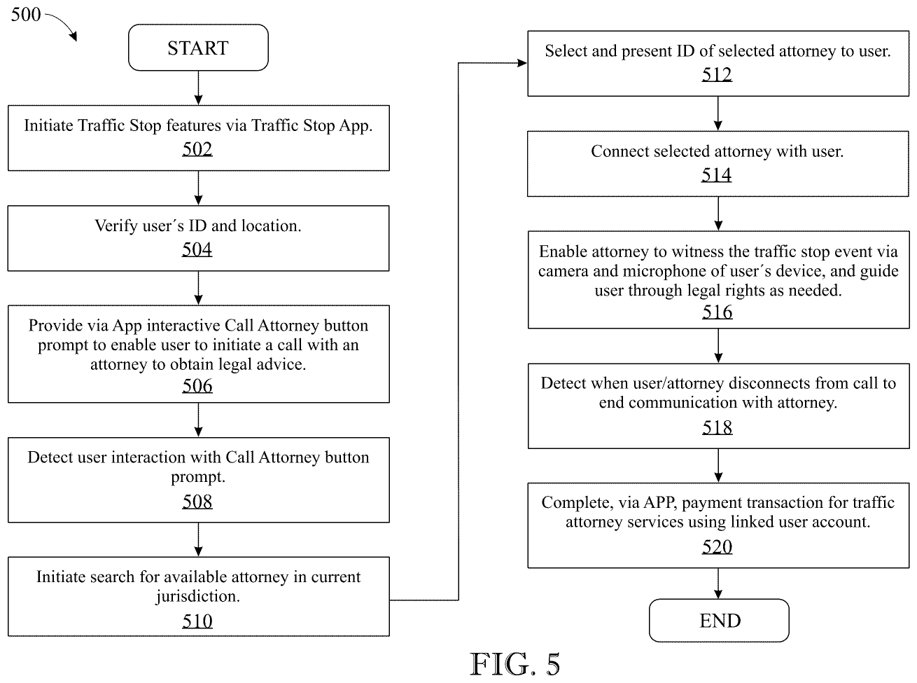

FIGS. 4-5 are flow charts illustrating various methods by which the above process of the illustrative embodiments is completed. Although the methods illustrated in FIGS. 4-5 may be described with reference to components shown in FIGS. 1-3, it should be understood that this is merely for convenience and alternative components and/or configurations thereof can be employed when implementing the various methods. Key portions of the methods may be completed by the TSC utility module 108 executing on processor subsystem 102 within DPS 100 (FIG. 1) and controlling specific operations of/on DPS 100, and the methods are thus described from the perspective of either/both the TSC utility module 108 and DPS 100 or other device that provides the functionality associated with one or more versions of the TSC utility module 108.

FIG. 4 presents a flow chart 400 illustrating the process of facilitating communication between a driver and an attorney during a traffic stop, according to one or more embodiments. The process of FIG. 4 begins at the initiator/start block and proceeds to block 402, at which the TSC utility module 108 receives an activation trigger from user indicating that the user wishes to start and utilize the TSMLCS app 114. At block 404, the TSC utility module 108 detects that the user is selecting access to the traffic stop features of the TSMLCS 114 as a result of the user's interacting with traffic stop icon. According to an aspect, the TSMLCS 114 is a mobile application that provides a user, such as a driver or a passenger, with traffic stop monitoring services and attorney advice services to facilitate protection of civil rights and overall safety of the user during traffic stop interactions with a police officer.

The TSC utility module 108 presents/provides to the user an interactive “Call Attorney” button prompt that when selected verifies that the user wishes to initiate a call with an attorney to obtain legal advice, as shown at block 406. According to an aspect, the TSC utility module 108 searches for attorneys in the area in which the user/driver is located/detained as a result of the traffic stop. According to an implementation, the TSC utility module 108 identifies one or more candidate attorneys in the area and chooses the attorney to provide legal counsel to the user based on a random selection. Alternatively, the TSC utility module 108 chooses the attorney to provide legal counsel to the user based on a balanced distribution of assigned jobs, according to attorney availability. According to an implementation, the TSC utility module 108 enables the user to choose from among the candidate attorneys a specific attorney from whom the user wishes to receive legal counsel.

At block 408, the TSC utility module 108 detects when a call to the attorney is being initiated by the user based on a detected user interaction with the “Call Attorney” button prompt. The TSC utility module 108 detects when an active call connection between the user and attorney has been established, as shown at block 410. As described in FIG. 3, when the user has reviewed via the GUI 110 the ID data corresponding to the attorney selected by the traffic stop application, the user is able to begin the call with the selected attorney by pressing/interacting with the CALL button 310 (FIG. 3).

According to one or more aspects, the TSC utility module 108 enables the attorney to witness the traffic stop event, via a camera and microphone of user's device, and to guide the user through understanding/asserting his legal rights as needed, as shown at block 412.

At block 414, the TSC utility module 108 creates an audio-visual record of the traffic stop to provide a form of legal documentation of the traffic stop incident/interaction. In response to detecting that traffic stop incident has ended, the TSC utility module 108 enables the user to save the record of the traffic stop to his personal files or to discard the record, as shown at block 416.

The TSC utility module 108 detects when the attorney/user disconnects from the call to end communication with the attorney, as shown at block 418. As described in FIG. 3, when the traffic stop, the consultation and/or the conversation is over, the user/attorney is able to end the call with the selected attorney by pressing/interacting with the DISCONNECT button 310 (FIG. 3).

At block 420, the TSC utility module 108 initiates an App rating feature to enable the user to rate the traffic stop app and/or the attorney service. According to one or more aspects, the TSC utility module 108 determines an overall rating for an attorney based on ratings provided by using the rating feature. According to an implementation, the TSC utility module 108 presents the overall attorney rating to a user to facilitate an attorney selection by the user. The process proceeds to the end block.

FIG. 5 presents a flow chart 500 illustrating the process of selecting and assigning an attorney to communication with a user in order to provide legal counsel, and providing payment for attorney services, according to one or more embodiments. The process of FIG. 5 begins at the initiator/start block and proceeds to block 502, at which the TSC utility module 108 initiates access (e.g., by selecting an appropriate tab or interactive button) to the Traffic Stop features via the TSMLCS App 114. At block 504, the TSC utility module 108 verifies the user's ID and location.

At block 506, the TSC utility module 108 provides an interactive Call Attorney button prompt to enable the user to initiate a call with an attorney to obtain legal advice. The TSC utility module 108 detects the call with an attorney being initiated by detecting the user's interaction with the Call Attorney button prompt, as shown at block 508.

According to one or more aspects, based on the user's location, the TSC utility module 108 initiates a search for available attorneys in a current jurisdiction in which the traffic stop has occurred, as shown at block 510.

According to an aspect, the TSC utility selects and presents the ID of the selected attorney to the user, as shown at block 512. According to an implementation, the TSC utility module 108 chooses the attorney to provide service to the user via a random selection process. The TSC utility module 108 connects the selected attorney with the user, as shown at block 514.

According to one or more aspects, the TSC utility module 108 enables the attorney to witness the traffic stop event, via a camera and microphone of user's device, and to guide the user through understanding/asserting his legal rights as needed, as shown at block 516.

At block 518, the TSC utility module 108 detects when the user/attorney disconnects from the call to end the user's communication with the attorney

According to an aspect, the TSC utility module 108 uses the traffic stop app to complete a payment transaction for the traffic attorney services using a linked user account, as shown at block 520. The process proceeds to the end block.

As described herein, a method, a system, and a computer program product provides traffic stop monitoring and legal counsel to a user involved in a traffic stop. A traffic stop counsel (TSC) utility/module enables the user to access traffic stop related features via a mobile traffic stop application. According to an aspect, the TSC utility enables the user to perform ID verification and to verify his location. Following ID and location verification, the TSC utility provides an interactive prompt that enables the user to call an attorney that is licensed in the current jurisdiction in order to receive legal counsel and advice during interactions with a police officer during the traffic stop. In response to a call between the user and the attorney being connected, the TSC utility enables the user to permit the attorney to witness the interaction via the user's mobile device. Additionally, the attorney is able to provide legal advice and guidance to the user during the traffic stop According to an aspect, the TSC utility enables the user to save a record of the traffic stop as a form of legal documentation. The TSC utility initiates a rating feature to enable the user to rate the traffic stop application and/or attorney service.

According to one or more aspects, the TSC utility module 108 determines an overall rating for an attorney based on ratings provided by various users/drivers using the rating feature.

According to an implementation, the TSC utility module 108 presents the overall attorney rating to a user to facilitate an attorney selection by the user.

According to one or more aspects, the user devices 204, 214, and 216 include a personal/laptop/tablet computer and a smartphone. According to an aspect, the data processing (user) device is one or more of an Android platform and an IOS platform device.

According to one or more aspects, the TSC utility module 108 and TSMLCS application 114 is used to activate live legal consultation/witnessing for motorists or other individuals that are involved in vulnerable situations based on encounters associated with routine traffic stops or any type of law enforcement encounter involving either a custodial interrogation or a non-custodial interrogation.

According to one or more aspects, the monitoring and attorney servicing functions provided by the TSMLCS application 114 can be initiated via one or more of voice activation, touch activation, and hands-free activation.

According to an aspect, in response to a user's request, the TSC utility module 108 can provide a livestream which can be recorded in the cloud to enable a safe and secure storage of the traffic stop record.

Those skilled in the art will appreciate that the present disclosure contemplates the use of systems configurations and/or computer instructions that may perform any or all of the operations involved in the dynamic workplace safety training services herein. The disclosure of computer instructions that include, for example, the TSMLCS app 114 is not meant to be limiting in any way. Those skilled in the art will readily appreciate that stored computer instructions and/or systems configurations may be configured in any way while still accomplishing the various goals, features, and advantages according to the present disclosure. The terms “program.” “application,” “software application,” and the like as used herein, are defined as a sequence of instructions designed for execution on a computer system. A “program,” “computer program,” “application,” or “software application” may include a subroutine, a function, a procedure, an object method, an object implementation, an executable application, an applet, a servlet, a source code, an object code, a shared library/dynamic load library, and/or other sequence of instructions designed for execution on a computer system. Accordingly, the applications herein may be written using any number of programming languages and/or executed on compatible platforms including, but not limited to, JavaScript, PHP (PHP: Hypertext Preprocessor), WordPress, Drupal, Laravel, React.js, Angular.js, and Vue.js. Computer readable program instructions for carrying out operations of the disclosed embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on one or more standalone computers, partly on one or more standalone computers, as a stand-alone software package, partly on one or more standalone computers and partly on one or more remote computers, partly on one or more standalone computers and partly on one or more distributed computing environments (such as a cloud environment), partly on one or more remote computers and partly on one or more distributed computing environments, entirely on one or more remote computers or servers, or entirely on one or more distributed computing environments. Standalone computers, remote computers, and distributed computing environments may be connected to each other through any type of network or combination of networks, including local area networks (LANs), wide area networks (WANs), through the Internet (e.g., using an Internet Service Provider), or the connection may be made to external computers.

Devices or system modules that are in at least general communication with each other need not be in continuous communication with each other, unless expressly specified otherwise. In addition, devices or system modules that are in at least general communication with each other may com-municate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention. A description of an embodiment with several components in communication with each other does not imply that all such components are required. On the contrary a variety of optional components are described to illustrate the wide variety of possible embodiments of the present invention.

As is well-known to those skilled in the art, many careful considerations and compromises typically must be made when designing for the optimal manufacture of a commercial implementation of any system, and in particular, the embodiments of the present invention A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Those of skill in the art will appreciate that where appropriate, some embodiments of the disclosure may be practiced in network computing environments with many types of computer system configurations, including personal computers, handheld devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices. “Software” may refer to prescribed rules to operate a computer. Examples of software may include code segments in one or more computer-readable languages; graphical and or/textual instructions; applets; pre-compiled code; interpreted code; compiled code; and computer programs. A network is a collection of links and nodes (e.g., multiple computers and/or other devices connected together) arranged so that information may be passed from one part of the network to another over multiple links and through various nodes. Examples of networks include the Internet, the public switched telephone network, wireless communications networks, computer networks (e.g., an intranet, an extranet, a local area network, or a wide area network), wired networks, and wireless networks.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s) It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium pro-duce an article of manufacture including instructions which implement the function/act specified in the flowchart and/or block diagram block or blocks. Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media. When a single device or article is described herein, it will be readily apparent that more than one device/article (whether or not they cooperate) may be used in place of single device/article. Similarly, where more than one device or article is described herein (whether or not they cooperate), it will be readily apparent that a single device/article may be used in place of the more than one device or article. The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, non-transitory media, volatile media, and transmission media. Non-volatile media include, for example, optical or magnetic disks and other persistent memory. Volatile media include dynamic random-access memory (DRAM), which typically constitutes the main memory. Transmission media include coaxial cables, copper wire and fiber optics, including the wires that com-prise a system bus coupled to the processor. Transmission media may include or convey acoustic waves, light waves and electromagnetic emissions, such as those generated during radio frequency (RF) and infrared (IR) data communications. Common forms of computer-readable media and non-transitory media include, for example, a floppy disk, a flexible disk, hard disk, magnetic tape, any other magnetic medium, a CD-ROM, DVD, any other optical medium, a RAM, a PROM, an EPROM, a FLASH-EEPROM, removable media, flash memory, a “memory stick”, any other memory chip or cartridge, a carrier wave as described hereinafter, or any other medium from which a computer can read. Various forms of computer readable media may be involved in carrying sequences of instructions to a processor. For example, sequences of instruction may be delivered from RAM to a processor, may be carried over a wireless transmission medium, and/or may be formatted according to numerous formats, standards or protocols, such as Bluetooth, 4G, 5G, etc.

As noted above, in some embodiments the method(s) described above may be executed or carried out by a computing system including a non-transitory computer-readable storage medium, also described herein as a storage machine, that holds machine-readable instructions executable by a logic machine (i.e., a processor or programmable control device) to provide, implement, perform, and/or enact the above-described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI), or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard, or gaming controller. For example, a user input may indicate a request that certain task is to be executed by the computing system, such as requesting the computing system to display any of the above-described information or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer program product such as via an application programming interface (API).

Thus, the steps of the disclosed method(s) and the associated discussion herein above can be defined by the computer program instructions stored in a memory and/or data storage device and controlled by a processor executing the computer program instructions. Accordingly, by executing the computer program instructions, the processor executes an algorithm defined by the disclosed method. For example, the computer program instructions can be implemented as computer executable code programmed by one skilled in the art to perform the illustrative operations defined by the disclosed methods. Further, it will be appreciated that any flowcharts, flow diagrams, state transition diagrams, pseudo code, program code and the like represent various processes which may be substantially represented in computer readable medium and so executed by a computer, machine, or processor, whether or not such computer, machine or processor is explicitly shown. One skilled in the art will recognize that an implementation of an actual computer or computer system may have other structures and may contain other components as well, and that a high-level representation of some of the components of such a computer is for illustrative purposes

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A non-transitory computer medium having executable code stored thereon, that when executed, cause a data processing system to perform operations comprising:
receiving an activation trigger from a first user device associated with a user during a law enforcement encounter;
responsive to the activation trigger, verifying the user's identity and current location;
prompting the user with an attorney call prompt for initiating a communication between the user and an attorney; and
receiving an activation of the attorney call prompt and establishing the communication between the user and the attorney.

2. The non-transitory computer medium of claim 1, wherein the operations performed by the data processing system further comprise:
in real-time during the communication established, providing real-time visual and audio access to the attorney of the law enforcement encounter.

3. The non-transitory computer medium of claim 2, wherein the operations performed by the data processing system further comprise:
receiving, by the user through the first user device, legal advice from the attorney during the law enforcement encounter.

4. The non-transitory computer medium of claim 1, wherein the operations performed by the data processing system further comprise:
creating and storing an audio-visual record of the law enforcement encounter.

5. The non-transitory computer medium of claim 2, wherein the operations performed by the data processing system further comprise:
requesting a rating from the user with respect to the attorney's performance during the law enforcement encounter.

6. The non-transitory computer medium of claim 5, wherein the operations performed by the data processing system further comprise:
receiving the rating from the user through the first user device.

7. The non-transitory computer medium of claim 3, wherein the operations performed by the data processing system further comprise:
enabling a payment from the user to the attorney associated with the legal advice received during the law enforcement encounter.

8. The non-transitory computer medium of claim 1, wherein the law enforcement encounter involves either a custodial interrogation or a non-custodial interrogation.

9. The non-transitory computer medium of claim 1, wherein the law enforcement encounter is any encounter between the user and a law enforcement officer that has a legal consequence to the user.

10. The non-transitory computer medium of claim 1, wherein the operations performed by the data processing system further comprise:
initiating a search for available candidate attorneys in a current jurisdiction associated with the law enforcement encounter to provide legal advice specific thereto, wherein each available candidate attorney is associated with a respective rating.

11. The non-transitory computer medium of claim 10, wherein the operations performed by the data processing system further comprise:
selecting the attorney from the available candidate attorneys in the current jurisdiction.

12. The non-transitory computer medium of claim 11, wherein the operations performed by the data processing system further comprise:
presenting an attorney identification (ID) and call status window identification (ID) information for the attorney.

13. The non-transitory computer medium of claim 1, wherein the operations performed by the data processing system further comprise:
detecting completion of the communication established between the user and the attorney.

14. The non-transitory computer medium of claim 11, wherein the selection of the attorney is a random selection from the available candidate attorneys in the current jurisdiction.

15. A non-transitory computer medium having executable code stored thereon, that when executed, cause a data processing system to perform operations comprising:
receiving an activation trigger from a first user device associated with a user during a law enforcement encounter;
responsive to the activation trigger, verifying the user's identity and current location;
prompting the user with an attorney call prompt for initiating a communication between the user and an attorney;
receiving an activation of the attorney call prompt and establishing the communication between the user and the attorney;
in real-time during the communication established, providing real-time visual and audio access to the attorney of the law enforcement encounter; and
receiving, by user through the first user device, legal advice from the attorney during the law enforcement encounter.

16. The non-transitory computer medium of claim 15, wherein the operations performed by the data processing system further comprise:
creating and storing an audio-visual record of the law enforcement encounter.

17. The non-transitory computer medium of claim 15, wherein the wherein the operations performed by the data processing system further comprise:
initiating a search for available candidate attorneys in a current jurisdiction associated with the law enforcement encounter to provide legal advice specific thereto, wherein each available candidate attorney is associated with a respective rating;
selecting the attorney from the available candidate attorneys in the current jurisdiction; and
presenting an attorney identification (ID) and call status window identification (ID) information for the attorney.

18. The non-transitory computer medium of claim 15, wherein the law enforcement encounter is any encounter between the user and a law enforcement officer that has a legal consequence to the user.

19. The non-transitory computer medium of claim 15, wherein the operations performed by the data processing system further comprise:
requesting a rating from the user with respect to the attorney's performance during the law enforcement encounter; and
enabling a payment from the user to the attorney associated with the legal advice received from the attorney during the law enforcement encounter.

20. A non-transitory computer medium having executable code stored thereon, that when executed, cause a data processing system to perform operations comprising:
receiving an activation trigger from a first user device associated with a user during a law enforcement encounter, wherein the law enforcement encounter is any encounter between the user and a law enforcement officer that involves either a custodial interrogation or a non-custodial interrogation;
responsive to the activation trigger, verifying the user's identity and current location;
prompting the user with an attorney call prompt for initiating a communication between the user and an attorney;
receiving an activation of the attorney call prompt;
responsive to the activation of the attorney call prompt received, initiating a search for available candidate attorneys in a current jurisdiction associated with the law enforcement encounter to provide legal advice specific thereto, wherein each available candidate attorney is associated with a respective rating;
selecting the attorney from the available candidate attorneys in the current jurisdiction;
presenting an attorney identification (ID) and call status window identification (ID) information for the attorney;
establishing the communication between the user and the attorney;
in real-time during the communication established, providing real-time visual and audio access to the attorney of the law enforcement encounter;
receiving, by the user through the first user device, legal advice from the attorney during the law enforcement encounter;
creating and storing an audio-visual record of the law enforcement encounter;
requesting a rating from the user with respect to the attorney's performance during the law enforcement encounter; and
enabling a payment from the user to the attorney associated with the legal advice received from the attorney during the law enforcement encounter.
